(19) United States
(12) Patent Application Publication
(10) Pub. No.: US 2008/0000211 A1
(43) Pub. Date: Jan. 3, 2008

(54) Discharge Chute Blocker

(75) Inventors: James Hafendorfer, Louisville, KY (US); Blake Whitley, La Grange, KY (US)

Correspondence Address: STOLL KEENON OGDEN, PLLC, 2000 PNC PLAZA, 500 WEST JEFFERSON STREET, LOUISVILLE, KY, 40202, US

(73) Assignee: Jungle Jim's Accessory Products, Inc., Louisville, KY (US)

(21) Appl. No.: 11/766,099

(22) Filed: Jun. 20, 2007

Related U.S. Application Data
(60) Provisional application No. 60/815,211, filed on Jun. 20, 2006.

(51) Int. Cl. A01D 75/18

(52) U.S. Cl. 56/320.2

(57) ABSTRACT

A discharge chute blocker system and method comprises a plate slidably mounted to a frame, which enables an operator to selectively block discharge as it travels through a discharge chute. Among other multiple embodiments and alternatives, a system and method for remote actuation of the discharge chute blocker is described.

This application benefits from Provisional Application No. 60/815,211, filed Jun. 20, 2006.

### BRIEF DESCRIPTION OF THE DRAWINGS

In the accompanying drawings:

FIG. 1 is a front perspective view of a discharge chute blocker affixed to a lawnmower, wherein the lawnmower is drawn in phantom, according to multiple embodiments and alternatives.

FIG. 2 is a front perspective view of a discharge chute blocker, according to multiple embodiments and alternatives.

FIG. 3 is a top perspective view of a discharge chute blocker, according to multiple embodiments and alternatives.

FIG. 3A is a top perspective view of a discharge chute blocker, according to multiple embodiments and alternatives.

FIG. 4 is a side perspective view of a discharge chute blocker, according to multiple embodiments and alternatives.

FIG. 5 is a side perspective view of parts for remote actuation of a discharge chute blocker, according to multiple embodiments and alternatives.

FIG. 6 is a side perspective view of a discharge chute blocker, according to multiple embodiments and alternatives.

### MULTIPLE EMBODIMENTS AND ALTERNATIVES

The phrases “for example” and “such as” are illustrative, and, therefore, are neither limiting nor exclusive.

A discharge chute blocker system is used to block objects from being discharged from a discharging apparatus, such as, for example, various kinds of lawnmowers, weedeaters, trimmers, chippers, shredders, mulchers, leaf blowers, snow blowers, and the like. Discharge, or related words derived from that word, means to expel with force. Discharged object means that which is discharged.

By way of example, not limitation, this specification illustrates a discharge chute blocker system in relation to a lawnmower. But it will be readily understood, by one skilled in the relevant art, that the teachings herein apply to numerous other kinds of apparatus that discharge objects.

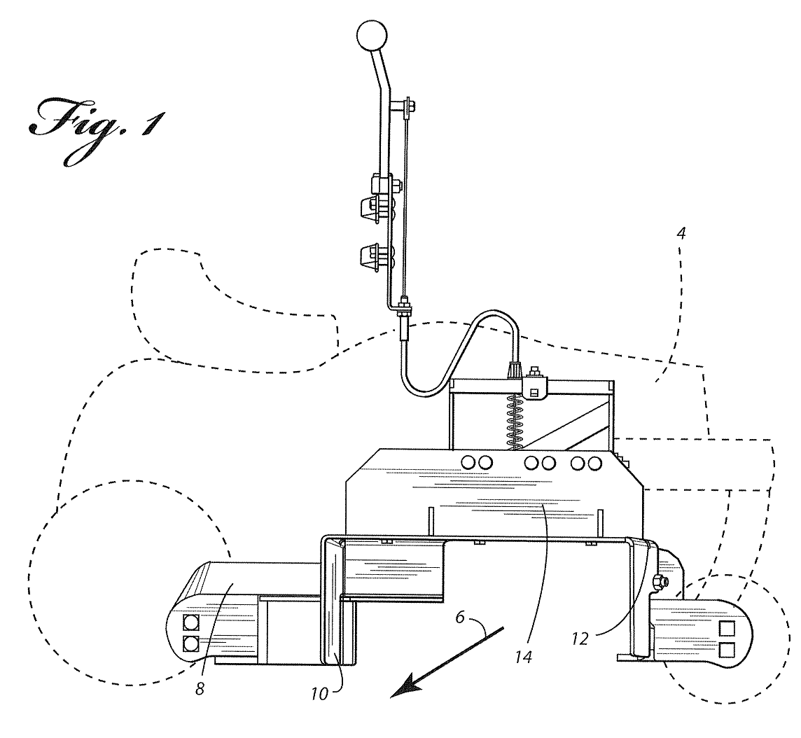

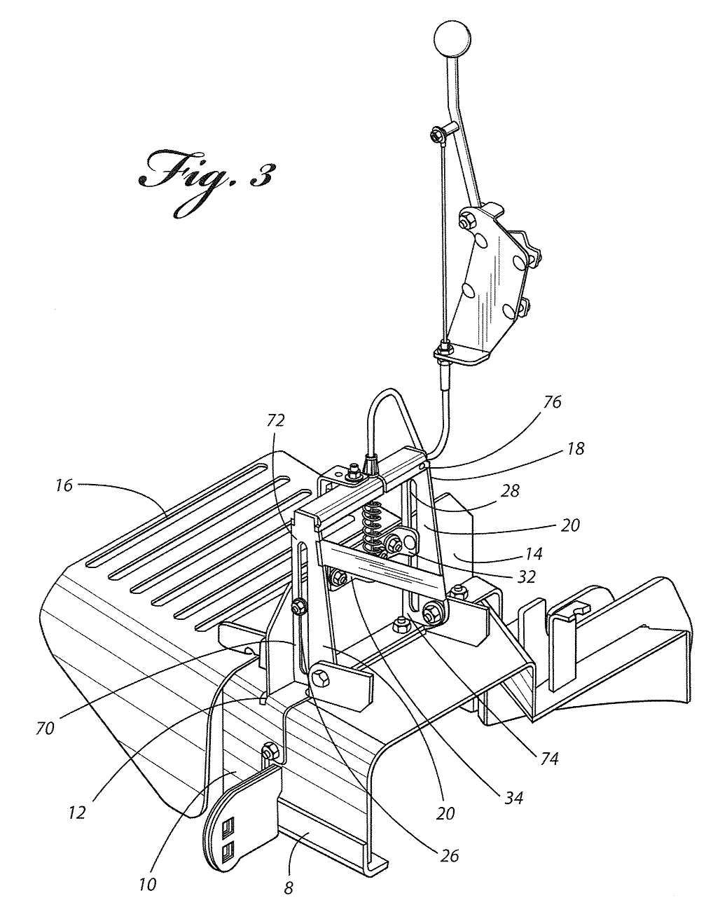

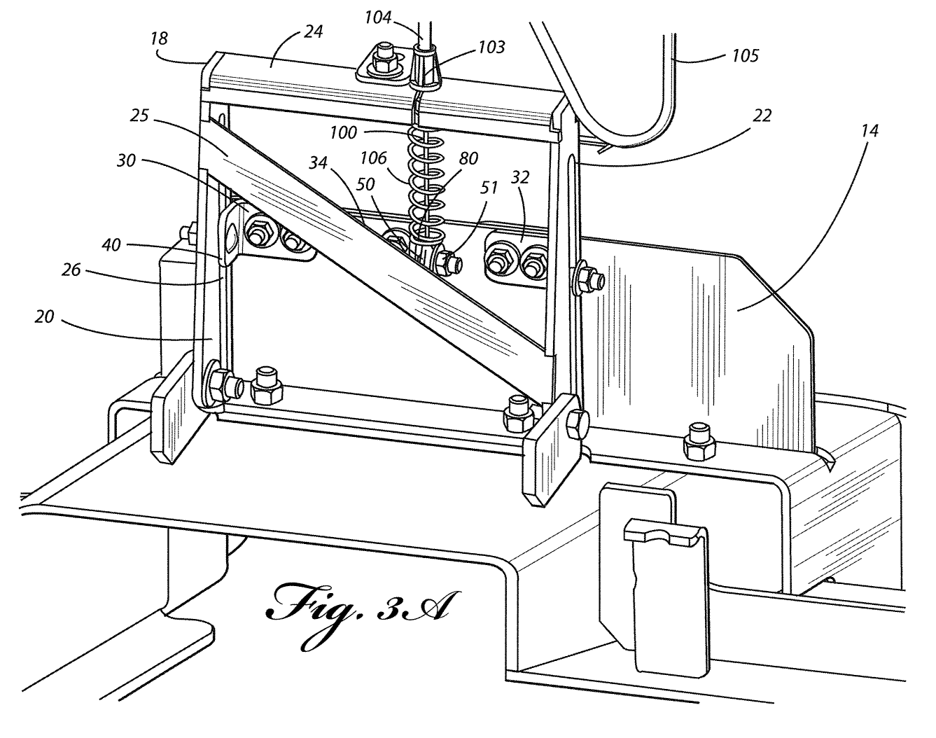

The rapid rotation of a lawnmower's 4 blades (not shown) discharges grass clippings and other discharged objects. Lawnmowers 4 typically have a discharge chute 6 and a deck 8, the latter of which covers the blades, in whole or part. FIGS. 1 and 3 illustrate the discharge chute blocker system having a casing 10 with a slot 12, wherein the casing 10 is affixed to the deck 8 by affixing means. Affixing means are chosen from the group bolting, screwing, gluing, and welding. While the exact details of affixing means that are referred to herein are not recited in the present teachings, it will be understood by those skilled in the art that it is within their capability to provide such fixing means in conjunction with the system and method of the multiple embodiments contemplated herein.

Referring again to FIG. 1, a discharge chute blocker system includes a plate 14 that is essentially flat and rigid. The plate 14 moves into, out of, and within the slot 12. In an embodiment, at a highest point of vertical movement, the plate 14 is in an unblocking position. Unblock, or related words derived from that word, means to allow discharged objects to pass unhindered by the plate 14. Starting from the highest point of vertical movement, as the plate 14 is lowered within the slot 12, it moves from an unblocking position toward a blocking position. Block, or related words derived from that word, means for the plate 14 to hinder the passage of discharged objects. At a lowest point of vertical movement, the plate 14 has the greatest amount of its surface area within the discharge chute 6.

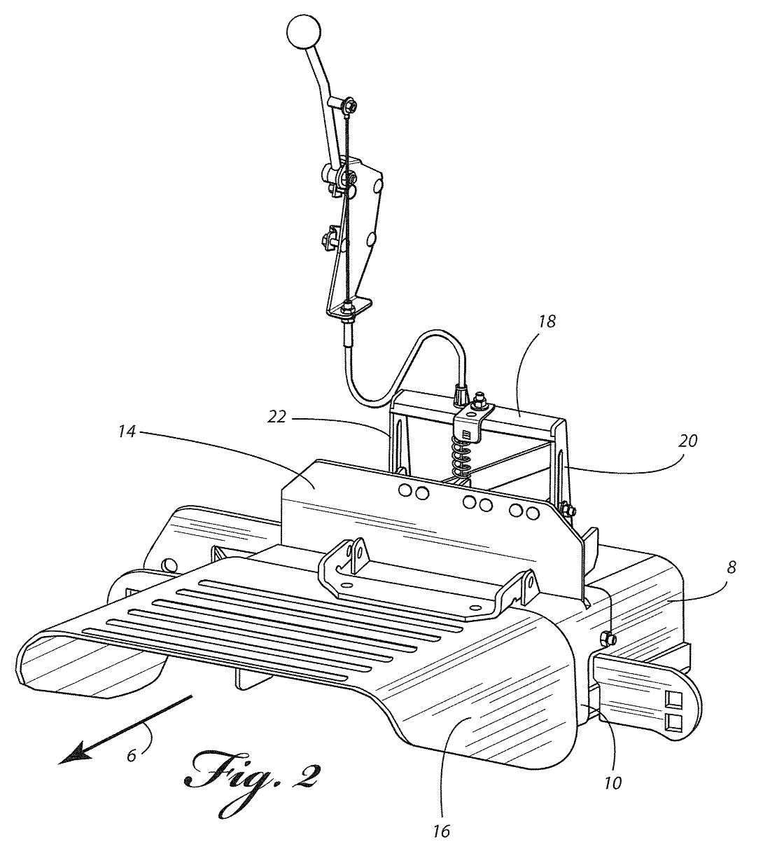

FIG. 2 illustrates a shroud 16 typically found on lawnmowers 4. The shroud 16 guides the clippings while passing through the discharge chute 6, and also serves as a safety feature per relevant standards and guidelines, such as, for example, American National Standards Institute (ANSI) Standard B71.4-2004. The discharge chute blocker system is installed by removing the shroud 16 from the deck 8. The casing 10 is then affixed to the deck 8. FIG. 2 illustrates the casing having an essentially inverted U-shaped orientation relative to the deck 8. The shroud 16 is then re-affixed to the casing 10.

Optionally, as FIG. 2 illustrates, the plate 14 is slidably mounted to a frame 18, having a first upstanding member 20, wherein the first upstanding member 20 is affixed to the deck 8 and the casing 10 by affixing means. In addition, the frame 18 has a second upstanding member 22, wherein the second upstanding member 22 is essentially parallel to the first upstanding member 20, and wherein the second upstanding member 22 is affixed to the deck 8 and the casing 10 by affixing means. In addition, the frame 18 has a cross member 24, wherein the cross member 24 is essentially perpendicular to the first upstanding member 20 and the second upstanding member 22, and wherein the cross member 24 is affixed to the first upstanding member 20 and the second upstanding member 22 by affixing means. Optionally, as desired by a user and as illustrated in FIG. 3A, a means for limiting deflection on the frame 18 includes a diagonal member 25, wherein the diagonal member 25 is angled relative to the cross member 24, and wherein the diagonal member 25 is affixed to the first upstanding member 20 and the second upstanding member 22 by affixing means.

As FIG. 3 illustrates, the frame 18 includes the first upstanding member 20 having a first end 70 proximal to the plate 14, and a second end 72 distal to the plate 14. In addition, the frame 18 includes the second upstanding member 22 having a first end 74 proximal to the plate 14, and a second end 76 distal to the plate 14. In an embodiment, a first frame slot 26 is located between first end 70 and the second end 72. In addition, a second frame slot 28 is located between the first end 74 and the second end 76. Optionally, the first frame slot 26 and the second frame slot 28 are essentially linear. Alternatively, the first frame slot 26 and the second frame slot 28 are curved.

FIGS. 3 and 3A illustrate a first bracket 30, a second bracket 32, and a third bracket 34, affixed to the plate 14 proximal to the first frame slot 26 and proximal to a top edge (not numbered) of the plate 14. The second bracket 32 is affixed to the plate 14 proximal to the second frame slot 28 and proximal to the top edge of the plate 14. Optionally, the third bracket 34 may be affixed to the plate 14 proximal to the top edge of the plate 14 between the first bracket 30 and the second bracket 32. The brackets 30, 32, and 34 are affixed to the plate 14 by affixing means.

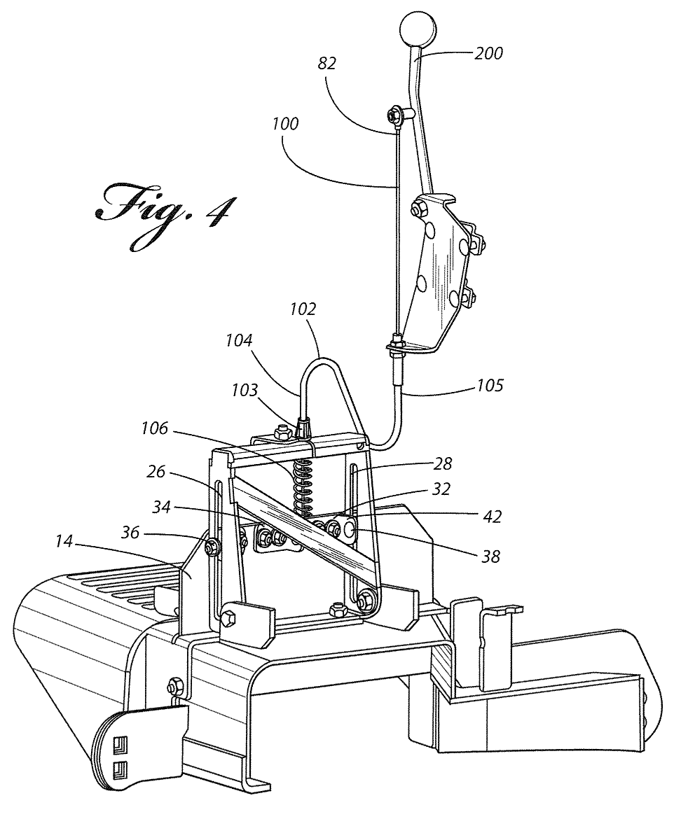

As FIGS. 3A and 4 illustrate, in an embodiment, the first bracket 30 includes a first guide flange portion 40. In addition, the second bracket 32 has a second guide flange portion 42, which FIG. 4 illustrates. In an embodiment, each of the first bracket 30, the second bracket 32, and the third bracket 34 are L-shaped. Alternatively, each is U-shaped. In another embodiment, the first guide flange portion 40 aligns with the first frame slot 26 to form a 90 degree angle with the plate 14. In addition, the second guide flange portion 42 aligns with the second frame slot 28 to form a 90 degree angle with the plate 14.

In FIG. 4, a first guide bolt 36 is inserted through the first frame slot 26, and affixed to the first guide flange portion 40. A second guide bolt 38 is inserted through the second frame slot 28, and affixed to the second guide flange portion 42. In this way, the first frame slot 26 and the second frame slot 28 define the vertical range of movement of the two guide bolts 36, 38. This range of movement, in turn, defines the movement of the plate 14, as it is affixed to the respective guide flange portions 40, 42 of the first bracket and the second bracket 30, 32.

In an embodiment, a plurality of openings (not shown) are formed in the guide flange portions 40, 42. The openings are formed in a geometrical configuration, such as, for example, square or hexagonal, in order to receive corresponding sholders of the guide bolts 36, 38 proximal to the head of the guide bolts 36, 38. The guide bolts 36, 38 are fixably inserted with lock nuts or other securing means through the openings of the guide flange portions 40, 42. In this way, the guide bolts 36, 38 do not rotate as they guide the plate 14 through its range of motion along the frame 18.

Alternatively, each of guide bolts 36, 38 has an end (not shown) proximal to the head of the bolt, from which an essentially cylindrical shank for each of guide bolts 36, 38 extends terminating in an annular ring upon which a threaded shank is disposed, essentially being smaller in diameter than the shank. The guide bolts 36, 38 are inserted through openings (not shown), and aligned with and inserted through frame slots 26, 28. A washer and lock nut are affixed to the threaded shank thereby securing the guide bolts 36, 38 within frame slots 26, 28. Alternatively, a metal sleeve shorter in length than the shank fits over the shank of guide bolts 36, 38 to guide flange portions 40, 42, and thereby allowing guide bolts 36, 38 to move in a path defined by frame slots 26, 28.

In an embodiment, the plate 14 is manually positioned. Alternatively, the plate 14 is remotely actuated. Turning now to lifting and lowering means for the plate 14, FIGS. 3A and 4 illustrate the use of a cable assembly that includes a cable 100 that is partially or fully encased by a sheath 102, a ferrule 103, and threaded tubing 108, wherein the sheath 102 has a first end 104 proximal to the plate 14, and a second end 105 distal to the plate 14. The ferrule 103 is affixed at the first end 104 of the sheath 102, and the threaded tubing 108 is affixed at the second end 105 of the sheath 102. The cable 100 is inserted through each of the ferrule 103, the sheath 102, and the threaded tubing 108. The ferrule 103 is affixed to the cross member 24 via a slotted opening 75 in the cross member 24, allowing access to the ferrule 103 and the cable 100, facilitating replacement or maintenance of all or parts of the cable assembly.

The cable 100 cable has a first end 80 (FIG. 3A) and a second end 82 (FIG. 4). The first end 80 of the cable 100 is affixed to the plate 14. The second end 82 of the cable 100 is distal to the plate 14. As FIG. 3A illustrates, a loop 50 is joined to the first end 80 of cable 100. A threaded bolt 51 is inserted through an opening (not shown) of the third bracket 34, then through the loop 50. A lock nut is affixed to the threaded bolt, thereby securing the loop in place Optionally, a washer assembly (not shown) may be placed between the loop 50 and the lock nut.

Returning to FIG. 4, as the cable 100 moves, the plate 14 also moves. For example, lowering the cable 100 moves the plate 14 from an unblocking position toward a blocking position. As another example, raising the cable 100 moves the plate 14 from a blocking position toward an unblocking position. In this way, a user can adjust the position of the plate 14 in order to selectably choose the location of the plate 14 within the discharge chute 6, as desired by a user.

As illustrated in FIG. 4, the sheath 102 directs the movement of the cable 100, so that the cable 100 does not interfere with operation of the discharge chute blocker system and method. In an embodiment, the sheath 102 extends into a ferrule 103 having a slightly lesser diameter than the sheath 102 so that the sheath 102 and the cable 1002 are snugly fitted within the ferrule 103. The cable 102 extends within the ferrule 103 through the cross member 24 via a slotted opening 75 in the cross member 24, allowing for access to the ferrule 103 and the cable 100 within should damage to the cable 100 occur.

Continuing with FIG. 4, a spring 106 wraps around the cable 100 proximal to the plate 14. The spring 106 further defines the range of movement of the plate 14. The spring 106 helps to urge the plate 14 downwardly when the cable 100 is lowered, moving the plate 14 toward the blocking position. Conversely, as the cable 100 is raised, moving the plate 14 toward an unblocked position, the spring 106 exerts downward force on the plate 14 relative to the cross member 24, thereby assisting to prevent excess noise and rattling movement of the plate 14.

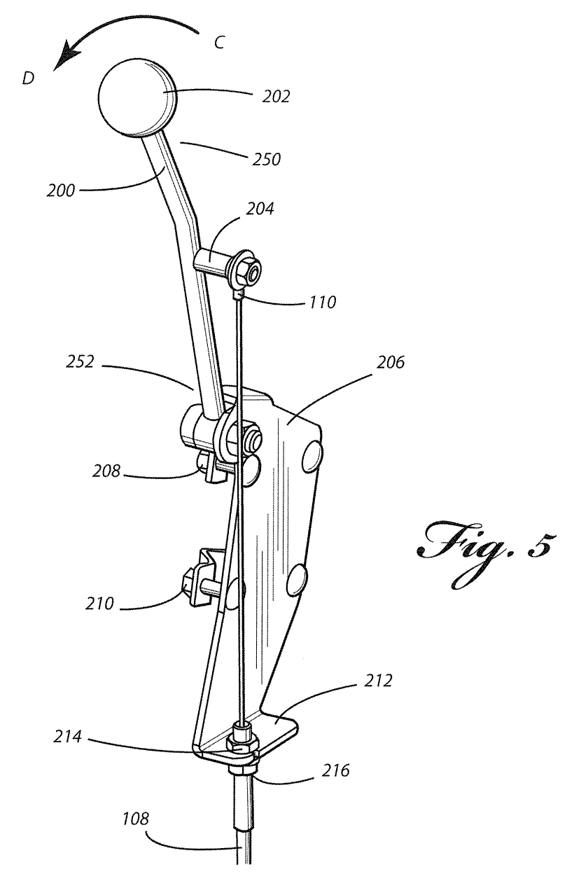

In an embodiment, a user selectably positions a handle 200 that is pivotable to either lower the plate 14 from an unblocking position toward a blocking position, or to raise the plate 14 from a blocking position toward an unblocking position. As illustrated in FIG. 5, the handle 200 may be formed in a tubular shape from metal material. The handle 200 has a first end 250 and a second end 252. The first end 250 has a grip member 202. In an embodiment, the grip member 202 is a ball made of rubber or plastic, having an essentially spherical shape. Alternatively (not shown), the grip member 202 may be formed from non-skid material applied to the first end 250 of the handle 200.

A cable securing means 204 is affixed to the handle 200. In an embodiment, the cable securing means 204 is a threaded tubular member inserted through an opening in the handle 200, and secured with a lock nut. Alternatively, the cable securing means 204 is secured with a dowel pin. In other embodiments, the cable securing means 204 is welded to the handle 200.

As illustrated in FIGS. 4 and 5, the second end 82 of the cable 100 includes a loop 110 affixed to the cable securing means 204 using, for example, a lock nut to secure the loop 110 to the cable securing means. Optionally, a washer assembly may be placed between the loop 110 and the lock nut. The second end 252 of the handle 200 is affixed to an angle plate 206 as illustrated in FIG. 5. A first angle plate bracket 208 proximal to the grip means 202 and a second angle plate bracket 210 distal to the grip means 202 hold the angle plate 206 stationary in relation to the handle 200.

Referring again to FIG. 5, the angle plate 206 has a shelf 212 that protrudes essentially perpendicular to a planar face of the angle plate 206. A piece of threaded tubing 108 is selectably located in relation to the shelf 212 by means of a top locking nut 214 and a bottom locking nut 216, which, when threaded as desired onto the threaded tubing 108, selectably adjust the positioning of the threaded tubing 108 in relation to the shelf 212, thereby enabling a user to augment or reduce tension on the cable 100 as desired. As the cable 100 is raised or lowered, the threaded tubing 108 and the sheath 102 (see FIG. 4) define the movement of the cable 100.

In an embodiment, the cable 100 is formed of braided or wrapped wire members of sufficient strength to raise the plate 14. Alternatively, the cable 100 is formed from solid core metals for increased rigidity and to allow movement of plate 14 even under compression loading of the cable 100.

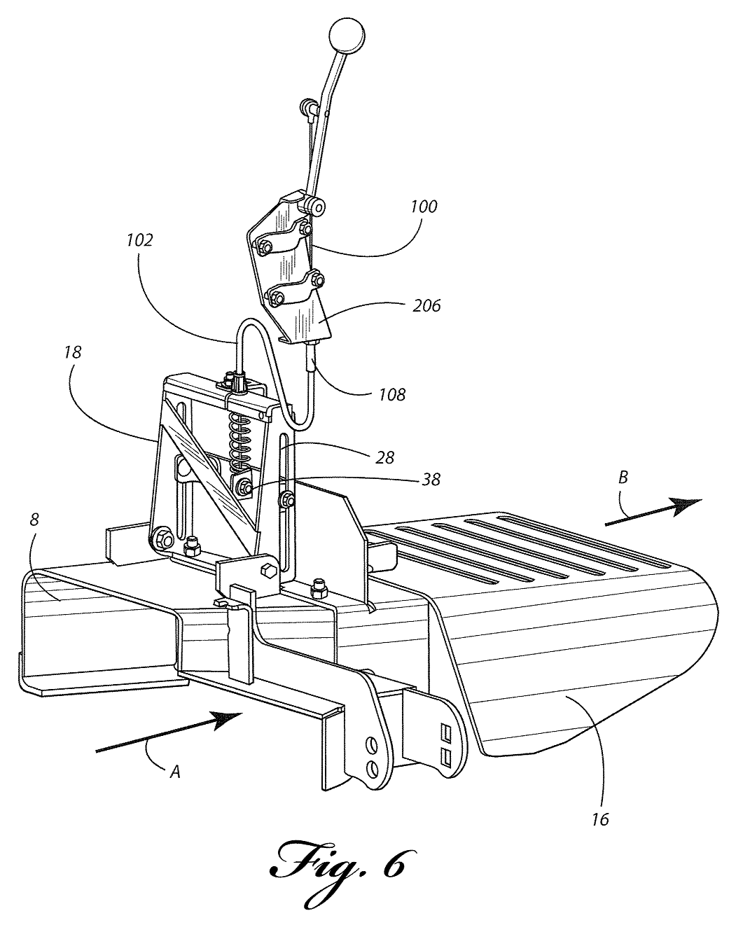

FIGS. 4 and 6 illustrate an example of a discharge chute blocker system ready for operation. A user may desire to block discharge moving through the discharge chute 6 in the direction indicated from point A to point B. FIG. 4 illustrates the handle 200 in an unblocking position, whereby deflection of the handle 200 has caused the handle 200 to pivot around the angle plate 206 in order to raise the cable 100, which in turn raises the plate 14.

When it is desirable or necessary to block discharge, the plate 14 can be lowered toward a blocking position. FIG. 5 illustrates the deflection of the handle 200 whereby the handle 200 has pivoted around the angle plate 206 (moving from point C to D) in order to lower the cable 100, which lowering would also move the plate 14 toward a blocking position.

Accordingly, remotely actuated embodiments of the discharge chute blocker are relatively easily and selectably operated by a user. Moreover, the discharge chute blocker system can be easily retrofitted to existing lawnmowers for either manual actuation or remote actuation.

As mentioned above, the discharge chute blocker system is not limited to lawnmowers. While the examples and alternative embodiments provided herein refer, in relation to a discharge chute on a lawnmower, to lowering the plate toward a blocking position, or raising the plate toward an unblocking position, other embodiments and alternatives may require the plate to move in different orientations relative to an apparatus or some other reference point. The embodiments and alternatives provided herein are not meant as limiting in this regard. Rather, applicants intend to teach and claim all patentable equivalents to the multiple embodiments and alternatives. For example, in various embodiments, a plate may be lowered into unblocking position and raised into blocking position. Or multiple plates may be made to converge toward a blocking position using the discharge chute blocker system, or diverge toward an unblocking position. Alternatively, using the discharge chute blocker method, a solid core cable is provided in order to move the discharge plate by means of compressive force as opposed to tensile force.

A discharge chute blocker method is used to block objects from being discharged from a discharging apparatus, such as, for example, those apparatus mentioned in connection with the discharge chute blocker system. Starting from an initial condition of an apparatus having a discharge chute 6 in an unblocked position (as in FIG. 1), a user performs the steps of:

Removing a shroud 16 from an apparatus, such as, for example, a lawnmower 4 (FIG. 1);

Affixing a casing 10 having a slot 12 to a deck 8 on an apparatus, such as, for example, a lawnmower 4, and then re-affixing the shroud 16 to the deck 8 (FIG. 1);

Affixing to the casing 10 and the deck 8 a frame 18 having a first upstanding member 20, a second upstanding member 22, and a cross member 24 affixed to upstanding members 20, 22 essentially perpendicular therebetween. Optionally, the frame 18 has a diagonal member 25 that is angled relative to the cross member 24, wherein the diagonal member 25 is affixed to upstanding members 20, 22; furthermore, upstanding members 20, 22, have frame slots 26, 28 (FIG. 3A);

Slidably mounting a plate 14 to the frame 18 for insertion into the slot 12 (FIG. 3);

Affixing to the plate 14 a first bracket 30, a second bracket 32, and a third bracket 34 therebetween, wherein brackets 30, 32, 34 are affixed proximal to a top edge of the plate 14, wherein first bracket 30 has a first guide flange portion 40 having an opening (not shown), and wherein second bracket 32 has a second guide flange portion 42 having an opening (not shown) (FIG. 3A);

Aligning the opening of first guide flange portion 40 with first frame slot 26 (FIG. 3A), and aligning the opening of second guide flange portion 42 with second frame slot 28 (FIG. 4);

Inserting and securing with a lock nut, washer, or other securing means as disclosed herein a first guide bolt 36 through the first frame slot 26 and the opening of first guide flange portion 40 (FIGS. 3A and 4);

Inserting and securing with a lock nut, washer, or other securing means as disclosed herein a second guide bolt 38 through the second frame slot 28 and the opening of the second flange portion 42 (FIG. 4);

Alternatively, a user fits over guide bolts 36, 38 a metal sleeve (not shown) shorter in length than the shank of guide bolts 36, 38, thereby preventing excess movement and wear on the threads of the shank of guide bolts 36, 38;

Forming a cable assembly as further disclosed herein having a first end and a second end, wherein the cable assembly has a cable 100 inserted through a ferrule 103, a sheath 102, and a threaded tubing 108 (FIG. 4);

Affixing the first end of the cable assembly to the plate 14, or to the third bracket 34 (FIG. 3A);

Forming a loop 110 (not shown) on an end of the cable 100 proximal to the second end of the cable (FIG. 5);

Wrapping a spring 106 around the cable 100 between the cross member 24 and the plate 14, thereby helping to define the range of movement of plate 14 and preventing excess noise and rattling movement of the plate 14 as it slidably moves on the frame 18 into, out of, and within slot 12 (FIG. 3A);

Affixing the loop 110 to a cable securing means 204 upon a handle 200 (FIG. 5);

Actuating the handle 200 by means of an angle plate 206 having a shelf 212 with an opening (covered in drawing), wherein the angle plate 206 is held stationary by angle plate brackets 208, 210 that are affixed to angle plate 206, and wherein threaded tubing 108 is inserted through the opening in shelf 212 (FIG. 5);

Adjusting the position of threaded tubing 108 relative to the shelf 212 by placement and tightening of a top locking nut 214 and a bottom locking nut 216 (FIG. 5);

Placing a grip means 202 at an end of the handle 200 distal to the plate 14 (FIG. 5);

Moving the handle 200 via the grip means 202 in order to deflect the handle 200 as desired by a user, in order to selectably move the plate 14 within the slot 12 by means of the cable 100 (FIGS. 4 and 5).

We claim:

1. A discharge chute blocker system, comprising a plate being slidably mounted on a frame affixed to a discharging apparatus, wherein the plate is capable of blocking a discharge chute of the discharging apparatus.

2. The discharge chute blocker system of claim 1, further comprising a casing having a slot, and means to affix the casing to a deck on a discharging apparatus.

3. The discharge chute blocker system of claim 2, wherein the plate is essentially flat.

4. The discharge chute blocker system of claim 2, wherein the plate is capable of movement relative to the slot formed in the casing.

5. The discharge chute blocker system of claim 2, wherein the casing is formed from at least one of the materials in the group metal, plastic, and aluminum.

6. The discharge chute blocker system of claim 2, wherein the casing is U-shaped and inverted relative to the deck.

7. The discharge chute blocker system of claim 2, wherein the frame is affixed to the casing.

8. The discharge chute blocker system of claim 7, wherein the frame comprises:
a first upstanding member having a first end and a second end;
a second upstanding member having a first end and a second end; and,
a cross member,
wherein
the cross member is essentially perpendicular to the first upstanding member and the second upstanding member; and,
opposite ends of the cross member are affixed to the first upstanding member and the second upstanding member.

9. The discharge chute blocker system of claim 8, further comprising a diagonal member, wherein opposite ends of the diagonal member are affixed to the first upstanding member and the second upstanding member.

10. The discharge chute blocker system of claim 8, further comprising a first frame slot positioned between the first and second ends of the first upstanding member, and a second frame slot positioned between the first and second ends of the second upstanding member.

11. The discharge chute blocker system of claim 10, further comprising a plurality of brackets affixed to the plate proximal to a top edge of the plate.

12. The discharge chute blocker system of claim 11, wherein the means of affixing the brackets are chosen from the group screws, bolts with nuts, rivets, glue, and welding.

13. The discharge chute blocker system of claim 12, wherein each of the plurality of brackets has a guide flange portion having an opening.

14. The discharge chute blocker system of claim 13, further comprising a plurality of guide bolts equal to the number of brackets having guide flange portions.

15. The discharge chute blocker system of claim 14, wherein each of the plurality of guide bolts is inserted through the opening in a guide flange portion of one of the brackets and then through one of the frame slots, then secured with a lock nut.

16. The discharge chute blocker system of claim 15, wherein the guide bolts securely inserted through brackets having flange portions and through frame slots define the movement of the plate.

17. The discharge chute blocker system of claim 10, wherein the first frame slot and the second frame slot are linear.

18. The discharge chute blocker system of claim 10, wherein the first frame slot and the second frame slot are curved.

19. The discharge chute blocker system of claim 16, further comprising remote actuation means comprising:
a handle;
a spring; and,
a cable assembly,
wherein
the cable assembly comprises a cable inserted through a sheath, a ferrule, and a threaded tubing;
a first end of the cable is affixed to the plate;
a second end of the cable is affixed to the handle;
the spring wraps around the cable;
the spring is located between the diagonal member and the plate;
and the spring helps to define the movement of the plate in response to movement of the cable.

20. The discharge chute blocker system of claim 19, further comprising a middle bracket affixed to the plate, wherein the first end of the cable is affixed to the middle bracket.

21. The discharge chute blocker system of claim 20, further comprising means to selectably position the handle.

22. The discharge chute blocker system of claim 21, wherein means to selectably position the handle comprise:
a grip member; and,
an angle plate,
wherein
the grip member is affixed to a first end of the handle;
a second end of the handle is pivotably affixed to the angle plate; and,
the second end of the handle is capable of rotational movement around a pivot point.

23. The discharge chute blocker system of claim 22, wherein the angle plate is held stationary relative to the handle by at least one angle plate bracket.

24. The discharge chute blocker system of claim 19, wherein the cable is attached to the handle by cable securing means comprising a threaded tubular member inserted through an opening in the handle, and securely held in place by means chosen from the group dowel pin, locking nut, weld.

25. A discharge chute blocker method, comprising:
affixing a casing having a slot to a deck;
affixing to the casing a frame; and,
slidably mounting upon the frame a plate,
wherein
the plate can be removably inserted into the slot.

33. The discharge chute blocker method of claim 32, wherein the frame is comprised of an first upstanding member, a second upstanding member parallel to the first upstanding member, and a cross member therebetween.

34. The discharge chute blocker method of claim 33, further comprising affixing a first end of a cable to the plate and affixing a second end of the cable to a lifting apparatus.

35. The discharge chute blocker method of claim 34, wherein the lifting apparatus is a movable handle affixed to a stationary angle plate.
